(19) United States
(12) Patent Application Publication
(10) Pub. No.: US 2018/0032920 A1
(43) Pub. Date: Feb. 1, 2018

(54) VEHICLE MANAGEMENT SYSTEM FOR VEHICLE-SHARING SERVICE

(71) Applicant: DENSO CORPORATION, Kariya-city (JP)

(72) Inventor: Akira ITO, Kariya-city (JP)

(21) Appl. No.: 15/658,643

(22) Filed: Jul. 25, 2017

(30) Foreign Application Priority Data
Jul. 27, 2016 (JP) 2016-147231

(51) Int. Cl. G06Q 10/02; G06Q 10/06

(52) U.S. Cl. CPC G06Q 10/02; G06Q 10/06313

(57) ABSTRACT

A vehicle management system for handling vehicle reservations of a vehicle-sharing service includes a reservation request input device, a reservation result transmitter, and a reservation processor. When a new vehicle reservation request is input to the reservation request input device, the reservation processor performs a simple process for a vehicle allocation which allocates a vehicle to the new vehicle reservation request, and the result transmitter transmits a reservation result to a user. When the time duration after the performance of the simple process and before the rental start time for the new vehicle reservation is equal to or greater than a threshold value, the reservation processor performs an optimization process to update the vehicle allocation for the new vehicle reservation request, quickly presenting a reservation result to the user while reducing an operation cost of the vehicle-sharing service.

### CROSS REFERENCE TO RELATED APPLICATION

The present application is based on and claims the benefit of priority of Japanese Patent Application No. 2016-147231, filed on Jul. 27, 2016, the disclosure of which is incorporated herein by reference.

### TECHNICAL FIELD

The present disclosure generally relates to a vehicle management system of a vehicle-sharing service.

### BACKGROUND INFORMATION

A vehicle-sharing service is a service for renting a vehicle to a user on demand, for example, in response to a user request. The service area of the vehicle-sharing service where the vehicle is rented is defined by a plurality of stations from which the vehicle is rented, or to which the vehicle is returned. Each of the plurality of stations has a stock of vehicles available for renting. In one form of the vehicle-sharing service, the user reserves (i.e., makes a reservation for) a vehicle via the Internet. The user then picks up the reserved vehicle at one of the plurality of stations designated during the vehicle reservation process.

The patent document 1 listed below discloses a management system for a car-sharing service renting electric vehicles. Such a system organizes and operates the rental service based on the electrical charge rate of each vehicle, i.e. basing vehicle rental availability on the electrical charge level of charging electric vehicles.

(Patent document 1) Japanese Patent Laid-Open No. 2014-41475

As disclosed in patent document 1, when the user makes a reservation, the reservation result may be presented to the user in response to a reservation operation. The reservation result in this case includes, for example, information regarding whether a reservation is accepted, as well as other information for the reserved vehicle. Vehicle allocation information may be presented to the user after updating the management system based on the new reservation by the user and the pending reservations of other users.

However, as the car-sharing service expands to cover a larger service area with a larger vehicle fleet, updates to the management system may take longer to process. In addition, the information collected and used to update the management system (e.g., utility costs associated with charging an electric vehicle, vehicle transfer operation costs (i.e., personnel expenses/labor cost for relocating a vehicle) may also increase, leading to far greater processing time for management system updates. Accordingly, the turn-around time from a user entering a reservation to the system displaying the reservation result may take too much time.

### SUMMARY

It is an object of the present disclosure to provide a vehicle management system for a vehicle-sharing service that reduces operating costs by optimizing vehicle allocation during a reservation process while quickly responding to and displaying a reservation result to a user.

In an aspect of the present disclosure, the vehicle management system for managing a vehicle-sharing service of one or more vehicles at one or more vehicle service stations includes: a reservation request input device configured to receive a vehicle reservation from an external computing device; a reservation processor configured to allocate a vehicle to the vehicle reservation request; a result transmitter configured to transmit a reservation result including a rental start time of the vehicle reservation to the external computing device; and a cost calculator configured to calculate an operation cost of the vehicle-sharing service, wherein the reservation processor is further configured to perform either a simple process or the simple process and an optimization process, for a vehicle allocation, wherein the simple process allocates the vehicle within a first processing time by either omitting a calculation of the operation cost by the cost calculator or simplifying the calculation of the operation cost by the cost calculator, and the optimization process allocates the vehicle within a second processing time using the cost calculator to calculate the operation cost based on a given condition to minimize the operation cost, and wherein the first processing time is shorter than the second processing time.

The vehicle management system performs the simple process for the vehicle allocation upon receiving an input of a new vehicle reservation from the user via the external computing device, and a reservation result including an allocation of a rental vehicle to the vehicle reservation request, processed using the simple process, is transmitted back to the external computing device for display to the user. The simple process is a process that is simpler and takes less time than vehicle allocation by the optimization process. For example, the simple process allocates a vacant vehicle to the vehicle reservation on a first-come, first-serve basis. Therefore, the reservation result is quickly transmitted back to the user with little or no wait time after the reservation operation by the user. The reservation result transmitted back to the user may simply be information about the validity of the reservation (i.e., whether the vehicle reservation has been accepted or declined), or may include information about the allocated vehicle (i.e., specifying an identity of the reserved vehicle).

For the new reservation, if the duration of time between the completion of the simple process and the rental start time is equal to or greater than a threshold value, the reservation processor performs the optimization process to update the vehicle allocation to the new vehicle reservation. In such manner, the operating costs of the vehicle management system are minimized for given conditions by changing the allocation of the vehicle(s) to the vehicle reservations.

The threshold value may be set to define a period of time that is longer than a processing time of the optimization process, which makes it possible to finish the optimization process before the rental start time for the reserved vehicle (i.e., before the use start time). Note that if the vehicle allocation is changed by the optimization process, the change of the vehicle allocation may be transmitted to the user in advance, i.e., prior to the use of the reserved vehicle, or the change of the vehicle allocation may be transmitted to the user, for example, at the rental vehicle pick up location, i.e. when the user visits the service station to pick up the reserved vehicle.

As described above, the vehicle management system may perform a two-part process, i.e., a simple, abbreviated process for a vehicle allocation in a shorter processing time, and a longer optimization process for a vehicle allocation that minimizes the operation costs of the vehicle-sharing service. In such manner, while the response (i.e., the reservation result) using the simple process is quickly transmitted back to the user, the service cost is efficiently minimized using the optimization process by reducing the operating costs of the vehicle allocation.

The present disclosure reduces the costs of a vehicle-sharing service by optimizing the vehicle allocation to the vehicle reservations and also provides a quick response to the user by quickly presenting the reservation result to the user in response to the user's reservation of a vehicle.

### BRIEF DESCRIPTION OF THE DRAWINGS

Objects, features, and advantages of the present disclosure will become more apparent from the following detailed description made with reference to the accompanying drawings, in which:

FIG. 1 illustrates a management system for a vehicle-sharing service and example infrastructure managed by the system;

FIG. 2 illustrates a block diagram of the management system in FIG. 1;

FIG. 3 illustrates a timing diagram of a service provision period and an off-service period of the vehicle-sharing service;

FIG. 4 illustrates a timing diagram for the electric charging of an electric vehicle;

FIG. 5 illustrates a timing diagram of a reservation process performed by the management system;

FIG. 6 illustrates another timing diagram of a reservation process performed by the management system;

FIG. 7 illustrates another timing diagram of a reservation process performed by the management system;

FIG. 8 illustrates another timing diagram of a reservation process performed by the management system;

FIG. 9 illustrates a flowchart of a process performed by the management system; and

FIG. 10 illustrates a flowchart of another process performed by the management system.

### DETAILED DESCRIPTION

Hereafter, exemplary embodiments of the present disclosure are described with reference to the accompanying drawings. For the ease of understanding and for the brevity of the description, the same numerals and reference characters are used to represent similar components in the respective drawings.

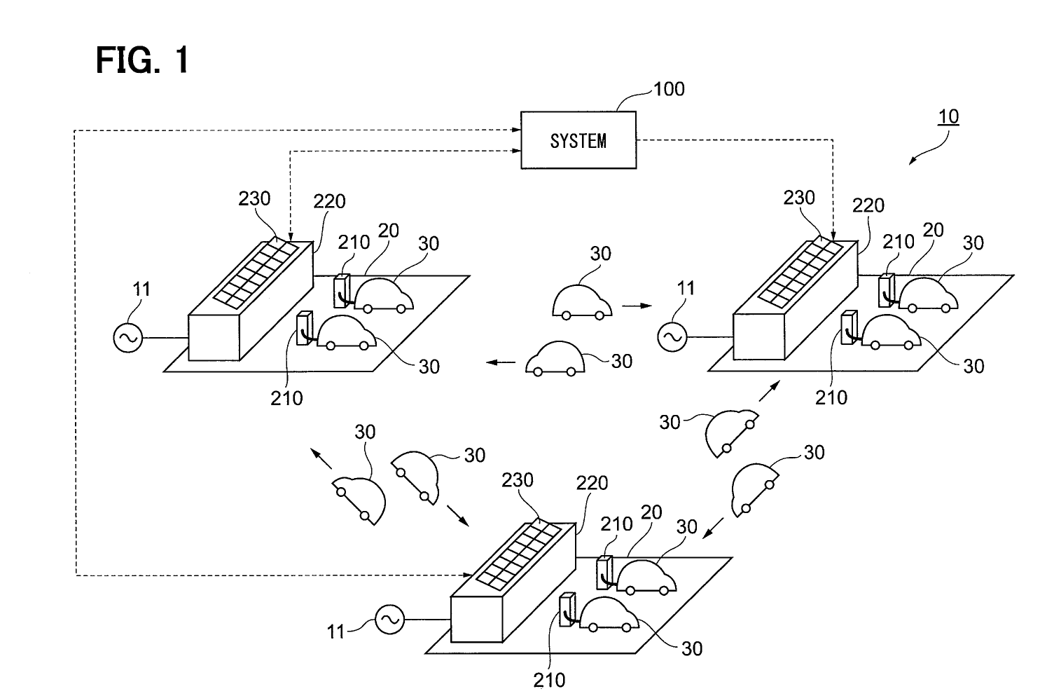

An outline configuration of a vehicle-sharing service using a vehicle management system 100 is described with reference to FIG. 1.

The vehicle-sharing service (also referred to herein as “service”) is a service that may provide a user with a short-term rental of a vehicle, for example an electric vehicle 30, after a rental request from the user.

The service may use elements such as one or more rental stations 20, electric vehicles 30, and the vehicle management system 100 to rent an electric vehicle 30 to a user, shown as components of vehicle sharing system 10.

The station 20 may provide a physical building 220 with a “window” or a “counter” that a user may visit for receiving service. For example, the building 220 can be staffed with a rental attendant that can assist a user with receiving service. Building 220 may also be an unstaffed building with an automated machine or kiosk to provide self-service to a user. Two or more stations 20 may be built in a specific geographic area (e.g., a service area) where the service is offered. For example, a user visits one of the stations 20 and to pick up an electric vehicle 30 to use as a rental vehicle. At or before the end of the rental period, the user then returns the electric vehicle 30 to a station 20 by bringing the vehicle to one of the stations 20. The station 20 from which a vehicle is borrowed and the station 20 to which the vehicle is returned may be the same station 20, or may be a different station 20. The station 20 may also be referred to herein as the service station 20.

According to the present embodiment, prior to receiving a rental vehicle from the service, the user reserves a vehicle 30. Further, at the time of making a reservation, the user specifies a borrow station 20, a return station 20, a rental start time, and a rental finish time.

The station 20 may be provided with the building 220, and parking spaces for the electric vehicles 30 are provided at the station 20, for example, surrounding the building 220.

The building 220 serves as a facility for providing service to the user and may provide an office for either a user or service personnel to complete work related to the service, for example, paperwork, reservation troubleshooting, and the like. The exemplary number of the stations 20 shown in FIG. 1 is three, but the number of the stations 20 in the service area may be more than three, or may be less than three.

A photovoltaic panel 230 may be disposed on a roof or top part of the building 220. The photovoltaic panel 230 converts sunlight energy to electric power. The station 20 may supply electric power generated by the photovoltaic panel 230 (i.e., solar-generated electric power) to the electric vehicles 30 parked at station 20 to charge the electric vehicles 30.

The station 20 may also receive electric power, i.e., grid power, from a power grid 11. The station 20 may also supply the grid power to the electric vehicles 30 to charge the electric vehicles 30.

In the space around the building 220, parking spaces (not illustrated) may be demarcated by lines painted on the ground. Each of the plurality of parking spaces may have a charger 210. The charger 210 charges the electric vehicle 30 parked in the parking space, for example, when the vehicle 30 is not in service. That is, the vehicle 30 and the charger 210 are connected by a cable, and an electric power is supplied by the cable from the charger 210 to the vehicle 30 for charging. The electric power supplied for the charging of the vehicle 30 may be a photovoltaic-generated power or power from the grid supply 11.

As shown in FIG. 1, each station 20 may have two chargers 210 and two parking spaces. However, the number of the chargers 210 and the parking spaces may vary. For example, the station 20 may have three or more chargers 210, or may have only one charger 210. That is, the number of the chargers 210 and parking spaces may vary from station to station.

The electric vehicle 30 has a secondary battery, or a storage battery, disposed therein (not illustrated) and uses the electric power stored in the storage battery to drive, i.e. propel, the vehicle. In addition to the above-mentioned storage battery, the electric vehicle 30 is provided with a power converter (not illustrated).

The power converter converts the electric power supplied from the charger 210, and charges the storage battery. At the time of charging, the power converter adjusts the electric power supplied from the charger 210 in a preset range to charge the electric vehicle 30.

Additionally, the electric power may be exchanged, i.e., supplied, from one vehicle 30 to another vehicle 30 parked in the same station 20. That is, one vehicle 30 in a station 20 may supply, i.e. transfer, the electric power stored in the vehicle's own storage battery to the storage battery of the other vehicle 30 via the charger 210, by discharging the electric power from the vehicle's own storage battery to charge the storage battery in the other vehicle 30.

As discussed above, the electric vehicle 30 may be borrowed from one station 20 and returned to another station 20, that is, the pick up location at the beginning of the rental period and drop off station 20 at the end of the rental period may not be the same station 20. However, as contemplated by the embodiments described herein, the vehicle user returns the electric vehicle 30 to one of the stations 20 after use.

Therefore, the electric vehicle 30 is either parked in one station 20 or in use (i.e. as a rented vehicle driven by a user) somewhere outside the station 20, during a service provision period, or in a certain time slot. That is, the electric vehicle 30 is in one of a parking state or use state during the service provision period.

The vehicle management system 100 may act as a control device that performs an overall control of the car-sharing system 10, in order to operate the car-sharing service. The vehicle management system 100 may be configured as a computer system with one or more computers having a CPU, a ROM, a RAM, and the like. In the embodiments described herein, the vehicle management system 100 may utilize both hardware and software to perform functions including, but not limited to, reservation input, reservation allocation, reservation optimization, reservation processing, cost calculation, the transmission of reservation results, and the like. For example, the vehicle management system 100 uses networking hardware such as routers, switches, gateways, bridges, hubs, wired and wireless interface controllers, modems, multiplexers, and the like to transmit and receive vehicle reservation data between computers in the management system 100 and other computers. The management system 100 may be installed in the station 20, or may be installed in a place other than the station 20. Further, the management system 100 may be provided as a cooperative system that is implemented by a cooperative operation of many computers and systems, for example, a plurality of computers and systems disposed in a plurality of stations 20. The vehicle management system 100 may also be configured with one or more servers to provide functionality to a variety of software and hardware clients. For example, the vehicle management system 100 includes one or more specialized servers to provide specific functionality to clients such as a database server, a file server, application server, web server, and the like.

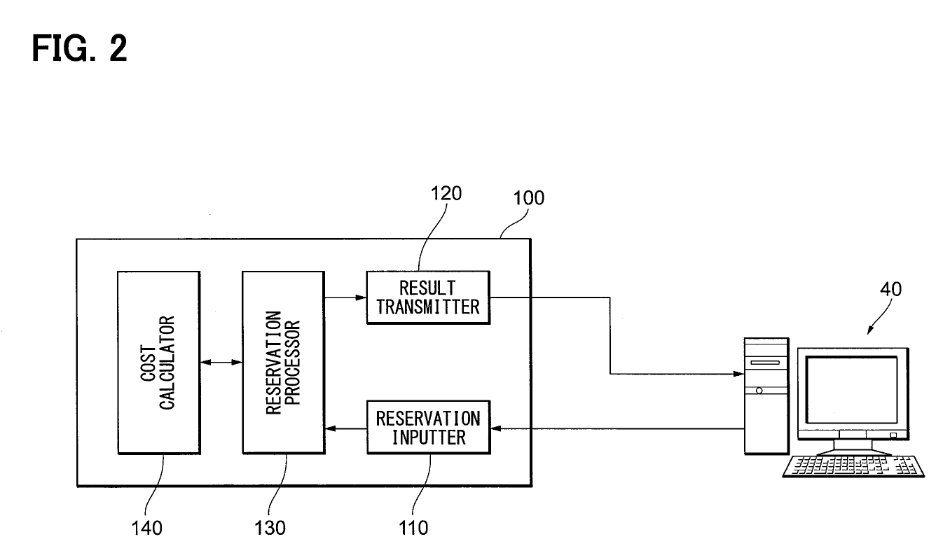

The management system 100 operates to receive a vehicle reservation from a user and operates to allocate an electric vehicle 30 to a user's vehicle reservation. The configuration of the management system 100 is described in the following with reference to FIG. 2.

FIG. 2 illustrates the management system 100 as functional blocks, including a reservation request input 110, a reservation result transmitter 120, a reservation processor 130, and a cost calculator 140. Though illustrated as function blocks in FIG. 2, each of the reservation request input 110, the reservation result transmitter 120, the reservation processor 130, and the cost calculator 140 includes hardware and software to perform, i.e., execute, the respective functions described below.

A user's computing device 40, such as a personal computer, may be disposed in a location remote from the management system 100, such as a user's house. As used herein, the computing device 40 may also be designated as “the personal computer 40,” to distinguish a user's computing device 40 from the management system 100. Further, the computing device 40 may also be referred to herein as the external computing device 40 to distinguish that the external computing device is separate from the computers and systems of the management system 100.

A user may use the personal computer 40 to interface with the vehicle management system 100 to reserve a vehicle 30. The external computing device 40 is not limited to a desktop computer in a user's home, and may include a computing device 40 at a service facility building 220, or a mobile terminal such as a smart phone, tablet computer, or the like.

The reservation request input 110 communicates with the user's personal computer 40 via the Internet, together with the result transmitter 120 described in further detail below.

The reservation request input 110 receives the vehicle reservation request data via the Internet when a user makes a vehicle reservation from the personal computer 40. That is, the vehicle reservation request data for an electric vehicle 30 is input from a user's computing device 40 to the system 100 by the reservation request input 110. The reservation request data may also be referred to herein as the reservation request, vehicle reservation, or reservation.

The vehicle reservation request data received by the reservation request input 110 is information including the pick up station 20 from which the user borrows the vehicle 30, the return or drop off station 20 to which the user returns the vehicle 30, the rental start time and the rental end time.

The result transmitter 120 transmits reservation result data for the user's vehicle reservation request via the Internet to the user (i.e., to the computing device 40). As used herein, reservation result data may be used interchangeably with reservation result to describe information transmitted to a user regarding a user's vehicle reservation in response to a user's vehicle reservation request.

The reservation result data is information which shows whether the vehicle reservation request data received by the reservation request input 110 is accepted or not, that is, whether the electric vehicle 30 is available for rent based on the reservation request made by the user. Further, the reservation result data includes, if the user's reservation request is accepted, information that identifies the electric vehicle 30 allocated to the user's vehicle reservation. The information for identifying the allocated electric vehicle 30 may be an individual ID that is assigned to the electric vehicle 30, for example, vehicle identification number, where an electric vehicle 30 or vehicle parking spot is marked with a number decal/indicia such the vehicle identification number to identify the vehicle to a user and/or service personnel. The individual ID may also include a vehicle description, for example, that the allocated vehicle is a red, 4-door sedan.

The reservation result data transmitted from the result transmitter 120 is displayed on a screen of the personal computer 40 in a presentable form to the user, such as text and graphics. That is, when a user performs an operation for making a vehicle reservation, reservation result data is transmitted from the result transmitter 120 back to the external computing device 40, and the reservation result data is displayed to the user.

When the rental start time arrives, the user visits the station 20 specified as the vehicle rental pick up station 20 when the reservation is made, and borrows the electric vehicle 30 designated in the reservation result data.

An IC card (i.e., smart card or chip card) may be used to store reservation result data and may be used for unlocking an electric vehicle 30.

When a user makes a vehicle reservation and the vehicle reservation request is not accepted due to too many reservations requests from other users, the result transmitter 120 transmits reservation result data back to the user indicating that the vehicle reservation is declined.

Based on the availability of vehicles, the reservation processor 130 allocates an electric vehicle 30 to each of the vehicle reservations request input into vehicle management system 100. The processing performed by the reservation processor 130 is described in greater detail below.

The cost calculator 140 calculates an operating cost for the vehicle-sharing service. The operating costs include, for example, the electricity costs for charging the electric vehicle 30 with the grid power. In other words, the utility costs associated with charging the vehicle 30 with grid power. Further, when a distribution of the electric vehicles 30 has accumulated at one of the plurality of stations 20, the electric vehicles 30 may have to be relocated, i.e., redistributed and driven/moved to other stations 20 by service staff, and the personnel expenses for moving the electric vehicles 30 to other stations 20 may also be counted as an operating cost. As discussed above, the cost calculator 140 includes hardware and software to perform cost calculation functions. The cost calculator 140 includes hardware to calculate electricity costs such as sensors and interfaces, for example, charge sensors, electric meters, and the like. Further, the cost calculator 140 may include hardware and software to calculate personnel costs, for example, sensors to collect time dock data, a software interface to payroll and accounting software, etc.

When the reservation processor 130 allocates an electric vehicle 30 to a vehicle reservation by a user, the above-mentioned operating costs are taken into consideration. Details of the reservation processor 30 are described in greater detail below.

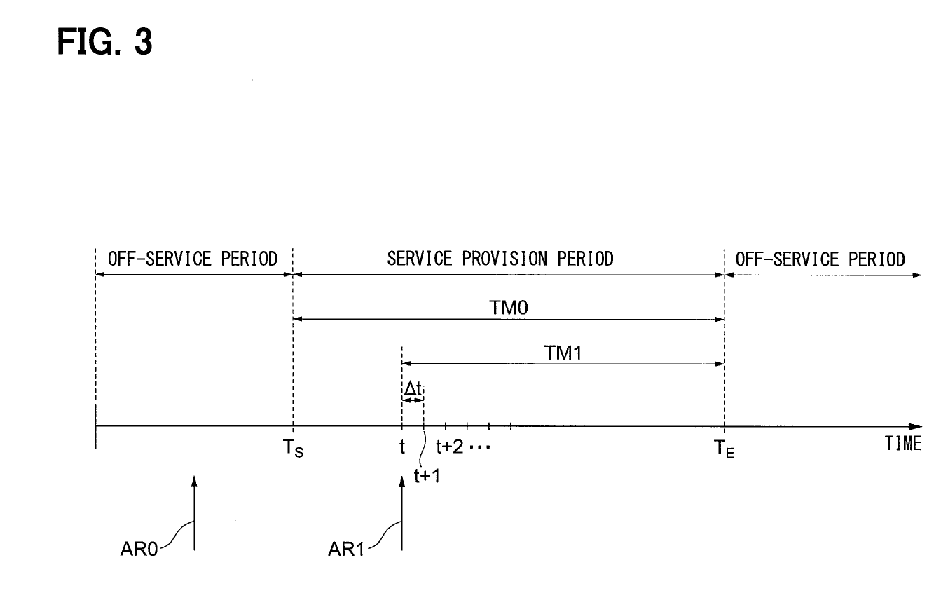

With reference to FIG. 3, an outline of processing by the vehicle management system 100 that is performed during a service provision period of the vehicle-sharing service is described.

The horizontal axis of the timing diagram shown in FIG. 3 shows a time of a day, i.e., 24 hours as a length from one side to the other. Time TS is a service start time when the vehicle-sharing service is started (i.e. opening hours when vehicle rental operations begin), which may be set as 8:00 a.m. in the present embodiment. Time TE is a service end time when the car-sharing service is finished (i.e. closing hours when vehicle rental operations conclude) for the day, which may be set as 8:00 p.m. in the present embodiment. That is, the service provision period of the car-sharing service is 12 hours from time TS to time TE. The period from time TE to the time of the next TS, for example, the following service day, is an off-service period. The user can make vehicle reservations at any time, that is, while a vehicle 30 is either in the service provision period or in the off-service period. Though an example 12 hour provision period is described, the service provision period may be any number of hours, including a 24 hour period.

For example, in case that an operation of the vehicle reservation is performed in the off-service period, which is shown by an arrow AR0 in FIG. 3, the vehicle management system 100 responds in the following manner.

When the vehicle reservation is input into the reservation request input 110, the reservation processor 130 determines whether the vehicle reservation of a subject vehicle 30 is acceptable, and when it is acceptable, the reservation processor 130 allocates the subject electric vehicle 30 to the respective vehicle reservation.

The vehicle allocation process for allocating the electric vehicle 30 to the reservation is actually performed as a two-part process. That is, the vehicle allocation is performed either as an abbreviated, “simple” process, or as a longer optimization process. As used herein, the abbreviated process may also be referred to as the simple process to distinguish the abbreviated process from the more process-intensive optimization process.

The optimization process performed by the vehicle management system 100 allocates the electric vehicle 30 so that the operating costs calculated by the cost calculator 140 are minimized under a given condition.

In performing the optimization process, the reservation processor 130 draws up a charge plan.

A charge plan is data in which a charging time slot for each of the electric vehicles 30 is shown as a scheduled data at the station 20. When a charge plan is made, a vehicle allocation plan is also made, in which vehicle reservations already input into the management system 100 are all listed as data, listing which electric vehicle 30 are assigned to which reservation.

Further, a vehicle location plan, that is, a position or location of each of the electric vehicles 30 relative to each of the stations 20, is also made at the same time, in which the location of each of the electric vehicles 30 in the service provision period is shown as data.

The charge plan, the vehicle allocation plan, and the vehicle position plan are all drawn up as a service operation plan of the vehicle-sharing service in a period TM0 from time TS to time TE.

The service operation plan, including the charge plan and the like, is made each time a vehicle reservation is input from a user to the reservation request input and the optimization process is performed in response to such input.

That is, the service operation plan for the period from time TS to time TE is updated whenever a vehicle reservation is input into the system 100. Therefore, the allocation of the electric vehicles 30 to all the vehicle reservations already input to the system 100 is updated and optimized each time a vehicle reservation is input into the system 100.

At time TS, the service provision period is started, and the vehicle-sharing service may be provided.

As the users start to use the electric vehicles 30, the electric vehicles 30 begin to move between the stations 20. As a result, the number of the electric vehicles 30 stopped/parked at each of the stations 20 (i.e., the number of vehicles in stock at each of the stations 20) changes from the number at an initial time state before time TS.

For example, at a certain point in time indicated by arrow AR1 in FIG. 3, a new vehicle reservation is made. Such a situation is described in greater detail below.

In such case, the same processing as the above is performed.

That is, when a new vehicle reservation is input to the reservation request input 110 and the optimization process is performed in response, the reservation processor 130 draws up an updated charge plan, an updated vehicle allocation plan, and an updated vehicle position plan, to reflect any changes to the charge, allocation, or location plans of the service operation plan.

These operation plans are drawn up as the service operation plan for a period TM1 from a current time t when the new vehicle reservation is input to the reservation request input 110 to time TE.

The charge plan, the vehicle allocation plan, and the vehicle location plan processes are described in greater detail below.

A charge plan is drawn up as data in the following form:
{p_{i,j}(τ|t)}

The above-mentioned “t” is the current time t when a vehicle reservation is input to the reservation request input 110. The term “τ” represents discrete points of time found in a period from the current time t to time TE, which may be, in other words, a moment with a Step of time period (Δt).

Although time τ after lapse of a Step of time period Δt from the current time t is “t+Δt”, it is simplified herein as “t+1,” as shown in FIG. 3.

Similarly, although time τ after lapse of Δt×2 from the current time t is “t+2Δt”, it is simplified herein as “t+2.” Time τ thereafter may also be represented in similar form. Time τ takes a value from t+1 to TE.

The above-mentioned “i” is a variable, identifying each of the stations 20, by taking an integer value. In the following, for example, the total number of the stations 20 is designated as S, and an individual ID from 1 to S is given to each of the stations 20. Therefore, the above-mentioned i takes an integer value from 1 to S.

The above-mentioned “j” is a variable, identifying each of the electric vehicles 30, by taking an integer value. In the following, for example, the total number of the electric vehicles 30 is designated as V, and an individual ID from 1 to V is given to each of the electric vehicles 30. Therefore, the above-mentioned j takes an integer value from 1 to V.

The number p_{i,j}(τ|t) is an amount of charge power that is charged to the electric vehicle 30 with an ID of j at time τ, which is after the current time t, at the station 20 with an ID of i.

The charge plan {p_{i,j}(τ|t)} is made up of data that shows a summation of the electric power to charge vehicles 30 for all combinations of the variables τ, i, and j. That is, the charge plan {p_{i,j}(τ|t)} is the data related to the schedule forcharging a vehicle 30 at a station 20 in a certain time slot, for each of the vehicles 30 with an ID of 1 to V.

The vehicle allocation plan is drawn up as data in the following form:
{a_{j,k}(t)}

In the above expression, “k” is a variable, identifying each of all vehicle reservations, including new vehicle reservations, that are already input to the system 100. In the following, the total number of vehicle reservations is designated as R, and an individual ID from 1 to R is given to each of the vehicle reservations. Therefore, the above-mentioned k takes an integer value from 1 to R. Note that, since the number R increases as a new vehicle reservation is input, it may more accurately be designated as “R(t)”.

The value a_{j,k}(t) is set to 1 when a vehicle reservation of an ID k has an electric vehicle 30 allocated thereto. Other than the above, the value a_{j,k}(t) is set to 0. That is, the value a_{j,k}(t) is either set to 0 or 1, for representing whether an electric vehicle 30 has been allocated or not. Thus, the vehicle allocation plan {a_{j,k}(t)} is made up as the data for representing all allocations of the electric vehicles 30 at the current time t for the combinations of variables j and k.

The vehicle location plan is drawn up as data in the following form.
{x_{i,j}(τ|t)}

When an electric vehicle 30 with an ID of j is parked at a station 20 with an ID of i at the time t, the value x_{i,j}(τ|t) is set to 1. Other than the above, the value x_{i,j}(τ|t) is set to 0.

The vehicle location plan {x_{i,j}(τ|t)} is made up as the data that shows the value x_{i,j}(τ|t) for all combinations of the variables τ, i, and j. In such manner, the location of an electric vehicle 30 at time τ is represented.

The vehicle location plan {x_{i,j}(τ|t)} should represent all vehicle locations, including if a vehicle 30 is parked at a station 20 or if a vehicle 30 is traveling on the road, (i.e., a vehicle not stopped or parked at the station 20). Therefore, while a vehicle stopped/parked at a station 20 is represented by the vehicle location plan {x_{i,j}(τ|t)} with the variable “i” indicating a station 20, a traveling vehicle 30 (not stopped/parked at any station 20) is described as stopped/parked at a station 20 with an ID of S+1, to indicate a non-existent station. In other words, a traveling vehicle's location is shown as S+1 indicating a non-existent station. Therefore, the vehicle position plan {x_{i,j}(τ|t)} has the variable i that takes an integer value from 1 to S+1.

The charge plan {p_{i,j}(τ|t)}, the vehicle allocation plan {a_{j,k}(t)}, and the vehicle location plan {x_{i,j}(τ|t)} are respectively calculated as the data which minimizes an operation cost E represented by the following equation (1) on a given condition.

That is, each of those plans is drawn up as a result of calculation that minimizes the operation cost E under a given condition.

$$E = {\sum }_{τ = i + 1}^{T - 1} {\sum }_{i 1 = 1}^{S} {\sum }_{i 2 = 1}^{S} {f}_{d} ( i 1 , i 2 , τ ) \cdot {d}_{i 1 , i 2} ( τ ) + {\sum }_{τ = t + 1}^{T} \{ {f}_{w} ( τ ) {\sum }_{i = 1}^{S} {w}_{i} ( τ ) Δ t \} + {\sum }_{τ = t + 1}^{T} \{ {f}_{l} ( τ ) {\sum }_{i = 1}^{S} {l}_{i} ( τ ) Δ t \} .$$

In the equation 1 the first term is

$${\sum }_{τ = i + 1}^{T - 1} {\sum }_{i 1 = 1}^{S} {\sum }_{i 2 = 1}^{S} {f}_{d} ( i 1 , i 2 , τ ) \cdot {d}_{i 1 , i 2} ( τ ) ,$$

the second term is

$${\sum }_{τ = t + 1}^{T} \{ {f}_{w} ( τ ) {\sum }_{i = 1}^{S} {w}_{i} ( τ ) Δ t \} ,$$

and the third term is

$${\sum }_{τ = t + 1}^{T} \{ {f}_{l} ( τ ) {\sum }_{i = 1}^{S} {l}_{i} ( τ ) Δ t \} .$$

Each term of the equation 1 is described as follows.

The value f_{d}(i1,i2,τ) in the first term is a function of the vehicle transfer operation cost (i.e., a vehicle relocation cost) for transferring a vehicle among the stations 20 by a staff member (i.e., not by the rental user). That is, f_{d}(i1,i2,τ) is a cost of a vehicle transfer from a station 20 with an ID of i1 to a station 20 with an ID of i2 at time τ. Note that f_{d}(i1,i2,τ) simply represents a transfer cost (i.e., an amount of money) in the above situation, and does not specify whether such a vehicle transfer is actually performed. Whether the vehicle transfer is actually performed or not is specified by d_{i1,i2}(τ).

The value f_{d}(i1,i2,τ) is a function of τ, because, for example, the transfer cost may vary due to different road congestion conditions in different time slots. Further, the staffs hourly expenses may also change for different time slots, for example, service staff may have higher wages on the weekend or holidays.

The value d_{i1,i2}(τ) in the first term is a function represented by the following equation 2:

$${d}_{i 1 , i 2} ( τ ) = {\sum }_{j = 1}^{V} {x}_{i 1 , j} ( τ ) \cdot {x}_{i 2 , j} ( τ + 1 ) \qquad [ Equation 2 ]$$

On the right side of the equation 2, the term x_{i1,j}(τ) takes a value of 1 when a vehicle 30 with an ID of j is parked at a station 20 with an ID of i1 at time τ. Further, the term x_{i2,j}(τ+1) takes a value of 1 when the vehicle 30 with an ID of j (i.e., the same vehicle 30) is parked at a station 20 with an ID of i2 at time τ+1 (after lapse of time Δt from time τ).

Therefore, the value of d_{i1,i2}(τ) represented by the equation 2 is equal to 1 when a vehicle 30 with an ID of j is transferred from a station 20 with an ID of i1 to a station 20 with an ID of i2 during the lapse of time Δt from time τ.

Based on the above, the first term of the equation 1 represents a vehicle transfer operation cost for a transfer of the vehicle 30 among different stations 20 by a staff of the car-sharing system 10, for accommodating a vehicle reservation.

Before describing the second term and the third term of the equation 1, gᵢ(τ), wᵢ(τ), and lᵢ(τ) are respectively described.

The value gᵢ(τ) is a value of the electric power able to be generated (i.e., generatable) by the photovoltaic panels at a station with an ID of i at time τ, and expressed in units of watts (“W”). Hereafter, it is designated as a “generatable power amount gᵢ(τ).”

The generatable power amount gᵢ(τ) is the data prepared in advance based on data obtained from weather agencies regarding the forecast of solar radiation amounts expected at each of the stations 20. In other words, the data is based on solar radiation that each of the stations 20 is expected to receive, based on forecasted weather data.

The data of the generatable power amount gᵢ(τ) is generated for each of the stations 20, i.e., for the station ID from 1 to S, and for each time τ in the period from time TS to time TE.

Note that the actual value of the photovoltaic power actually generated at time τ at the station 20 is not necessarily in agreement with the data of the generatable power amount gᵢ(τ).

For example, even when a sufficient amount of solar radiation is received by the photovoltaic panel 230 at a station 20, the generated electric power from the panel 230 cannot be charged to the battery of the vehicle 30 when no electric vehicle 30 is parked at the station 20.

Therefore, the photovoltaic panel 230 may be configured to automatically suppress a power generation amount in such a situation. Thus, the generatable power amount gᵢ(τ) is rather a maximum generatable amount of electric power at the station 20 at time τ.

The value wᵢ(τ) is defined as a power amount that is calculated by deducting an actual generated electric power amount at the station 20 with an ID of i from the above-mentioned generatable power amount gᵢ(τ), and expressed in units of watts (W).

Such a value wᵢ(τ) may thus be designated as an opportunity-loss power amount wᵢ(τ), i.e., an amount of electric power that may have otherwise been charged to the battery of the electric vehicle 30 at the station 20 but is lost due to the absence of the vehicle 30, or the like.

The value lᵢ(τ) is a value of the grid power that is supplied to a station with an ID of i at time τ, and expressed in units of watts (“W”). In the following, it is designated as the grid power amount lᵢ(τ).

The grid power amount lᵢ(τ) is associated with the above-mentioned generatable power amount gᵢ(τ) and the opportunity-loss power amount wᵢ(τ) by the following equation 3:

$${w}_{i} ( τ ) = {l}_{i} ( τ ) + {g}_{i} ( τ ) - {\sum }_{j = 1}^{V} {p}_{i , j} ( τ \vert t ) \qquad [ Equation 3 ]$$

For example, in a time slot in which the generatable power amount gᵢ(τ) takes a relatively small value, the value of the grid power amount lᵢ(τ) is adjusted so that the charging is performable as planned according to the charge plan {p_{i,j}(τ|t)}. As a result, the value of the opportunity-loss power amount wᵢ(τ) in the given time slot becomes 0 (i.e., decreases to 0).

In a time slot in which the generatable power amount gᵢ(τ) takes a relatively large value and the need for the charging is relatively low, the grid power amount lᵢ(τ) becomes zero and the opportunity-loss power amount wᵢ(τ) takes a value that is greater than zero.

In the calculation for minimizing the operation cost E with the equation 1, in order to perform the charging according to the charge plan {p_{i,j}(τ|t)} using as much electric power supplied from the photovoltaic as possible, the value of the grid power amount lᵢ(τ) is suitably adjusted for each of the time τ.

The value f_{w}(τ) in the second term of the equation 1 converts a photovoltaic electric power in a unit of 1 watt-hour into a monetary value.

The value f_{w}(τ) may be described as a function of price, for example, in an instance where electric power generated by photovoltaic panels 230 is sold to a grid-power company at time τ.

The second term of the equation 1 is equivalent to an integration value over the period of time after the current time t of a product of a summation of the opportunity-loss power amounts wᵢ(τ) of all the stations 20 multiplied by the value f_{w}(τ) described above.

That is, the second term represents a value of loss, or the amount of money, of the opportunity-loss power amount wᵢ(τ) for the remaining service provision period.

The value fₗ(τ) in the third term of the equation 1 converts a grid power in a unit of 1 watt-hour into the amount of money for valuation.

The value fₗ(τ) corresponds to a selling price for selling generated power to a grid-power company.

The third term of the equation 1 is equivalent to an integration value over the period of time after the current time t of a product of a summation of the grid power amount lᵢ(τ) of all the stations 20 multiplied by the value fₗ(τ) described above.

That is, the value of the third term represents a monetary cost or a “grid-charge cost”, i.e., the cost to charge each of the electric vehicles 30 using grid power for the remaining service provision period of the day.

In the optimization process, the operation cost E, that is a sum of the first, second and third terms, described above, is minimized by suitably generating the charge plan {p_{i,j}(τ|t)}, the vehicle allocation plan {a_{j,k}(τ)}, and the vehicle position plan {x_{i,j}(τ|t)}. These plans are made according to the calculation of the reservation processor 130, based on the calculation of the operation cost E by the cost calculator 140.

In the course of the calculation for minimizing the operation cost E, various initial conditions and various restrictions are considered. That is, the minimization calculation is performed under the plurality of conditions.

The initial conditions may be, for example, set as the current position of each of the electric vehicles 30. The initial condition of the vehicle position corresponds to each of the values of the vehicle position plan {x_{i,j}(τ|t)} at the time of τ=0.

The amount of charged electricity (SOC: State of Charge) for each of the storage batteries in each of the electric vehicles 30 at the current time (τ=0), may also be set up as the initial condition.

The information regarding the initial SOC may be obtainable, for example, via the communication between the electric vehicle 30 and the charger 210. As described above, the cost calculator 140 includes hardware and software to perform its given cost calculation function. For example, the cost calculator includes communication hardware to communicate with either the electric vehicle 30 or charger 210 to obtain SOC data.

As an exemplary restriction condition (‘restriction’), the value of SOC at time TE for each of the storage batteries carried in each of the electric vehicles is set.

That is, a target value of SOC (i.e., the amount of stored electric power) at the end time of the service provision period may be set up as a restriction. While it may be desirable to have the SOC value at the end of the service provision period set as a “larger-the-better,” or maximum value, this may not always be the case. For example, if the target SOC value is set to 100% uniformly for all batteries, setting the target SOC to this value may raise the opportunity-loss power amount wᵢ(τ) of the next day. Therefore, it is not necessarily desirable to set the SOC value to a “larger-the-better” or maximum value. That is, the target SOC value at the end of the service provision period, for example, may be set uniformly to 50%. However, the target SOC value may be set based on other factors such as weather. For example, the target SOC may be set to 30% during clear, sunny days, and 80% during rainy days.

By setting the above restrictions, the reservation processor 130 makes the charge plan {p_{i,j}(τ|t)} and the like for controlling the SOC of each of the electric vehicles 30 to match the target SOC value at the end of the service provision period of the vehicle-sharing service.

As another exemplary restriction condition, a usage amount (i.e., decrease) of stored electric power during period (Δt) of vehicle travel is set individually for respective electric vehicles 30.

Other exemplary restrictions include, setting individual upper limits and lower limits of SOC for respective electric vehicles 30 operated by the service. In such manner, the reservation processor 130 makes the charge plan {p_{i,j}(τ|t)} and the like based on an assumed condition that the SOC of the electric vehicle 30 in the service operation is kept within a range between a lower limit and an upper limit.

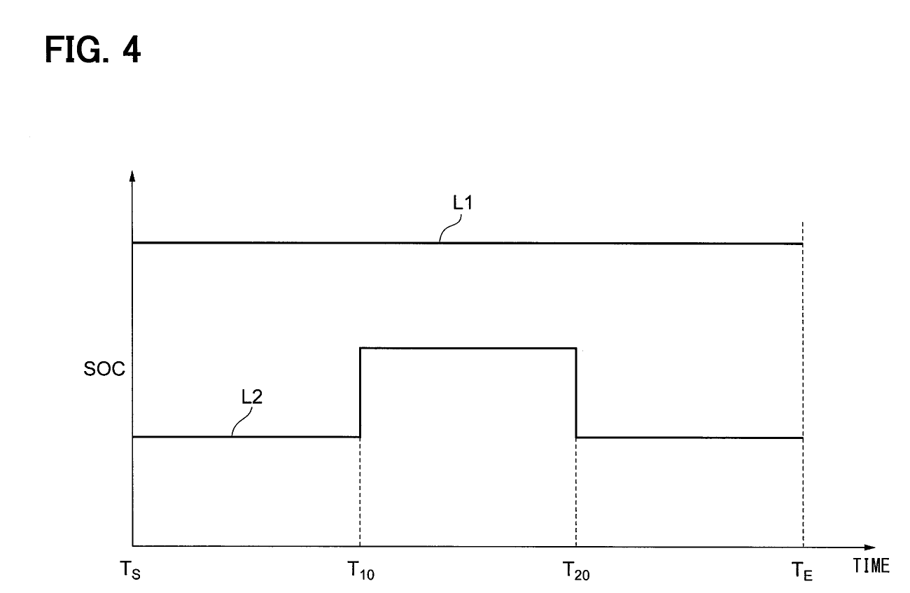

FIG. 4 shows an example of transition of SOC upper/lower limit values serving as the restrictions, by a line L1 and a line L2. In the example of FIG. 4, the upper limit of SOC is set up as 100% uniformly, and that value does not change.

On the other hand, the lower limit of SOC is set up to temporarily increase in a period from time T10 to time T20.

For example, where a time slot for vehicle reservation is in high demand, or where the system predicts an increase in the renting of vehicles 30, it may be desirable to raise the lower limit of SOC temporarily in such a time slot. In such manner, the system prevents the electric vehicle 30 from running out of stored electrical power during operation. Note that the example shown in FIG. 4 is but one example case, and other conditions may also be set by the system. For example, the upper limit of SOC may vary as a function of time, similar to the lower limit, as described above.

The upper limit and the lower limit of charging power during the charging of the electric vehicle 30 may additionally be set as the restrictions.

Additionally, during the exchange of power between electric vehicles 30 (i.e., electric power from one vehicle 30 used to charge another electric vehicle 30), the upper limit lower limits of electric power discharge from the electric vehicle 30 may be set as a restriction.

Note that when performing the calculation for minimizing the operation cost E, other additional real world restrictions may apply. For example, the number of the electric vehicles 30 allocated to one vehicle reservation is set to 1.

As mentioned above, the operation cost E, calculated by the cost calculator 140 in the optimization process, may be minimized by the vehicle allocation plan {a_{j,k}(t)} generated under given conditions (e.g., under the initial condition and restrictions), and as a result of such plan, an allocation of an electric vehicle 30 to a vehicle reservation is performed.

The optimization process is performed, as described above, by taking various conditions into consideration, such as a position, an amount of stored electric power, etc., of each the electric vehicles 30 in service.

Therefore, when the scale of service becomes large, the processing time for the optimization process may increase, for example, taking 15 minutes or more. In such case, it is not practical to keep a user waiting for long periods during the vehicle reservation process, while the optimization process is carried out.

Therefore, the reservation processor 130 is configured for performing a simple, abbreviated processing (used herein as “simple” or “abbreviated” process) in addition to the above-mentioned optimization process. The abbreviated process is a process that allocates the electric vehicle 30 in a shorter period of time than the optimization process, by omitting or simplifying the calculation of the operation cost E by the cost calculator 140.

An example of the simple process may be processing that allocates a “vacant” electric vehicle 30 to the vehicle reservation on a first-come, first-serve basis, without taking the operation cost E into consideration.

In such case, since the calculation of the operation cost E shown in equation 1 is omitted, the calculation load is made lighter and the allocation of the electric vehicle 30 to a vehicle reservation request is processed in a shorter period of time.

Another example of the simple process omits the first term of the operation cost E in Equation 1, that is, the simple process is carried out without taking the vehicle transfer operation cost, or the vehicle relocation cost into consideration.

In such case, since calculation of the operation cost E is simplified, allocation of the electric vehicle 30 takes less time than the allocation time used by the optimization process.

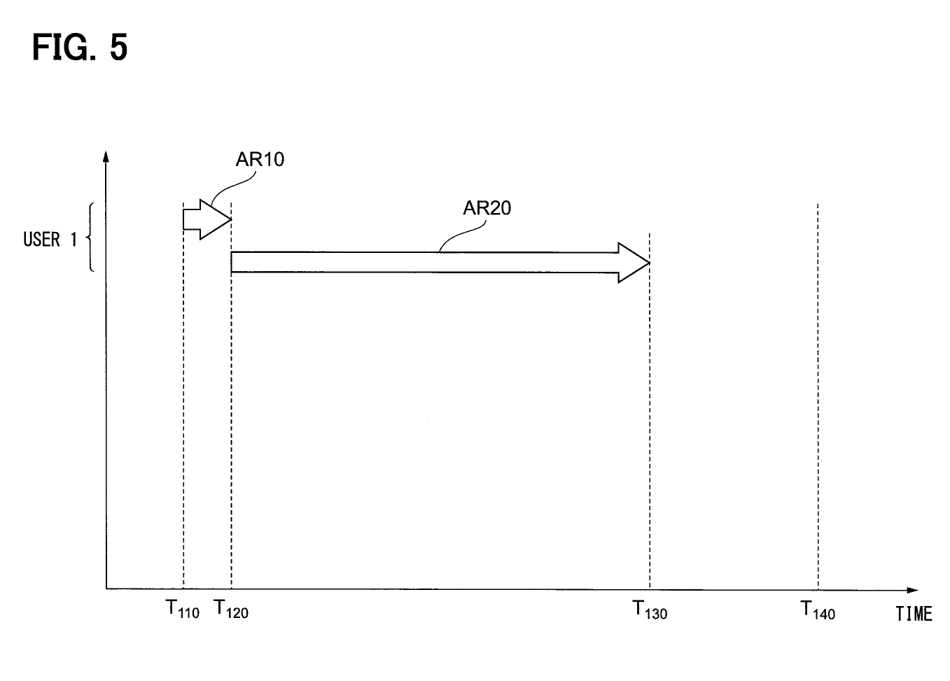

An example of the processing performed by the system 100, when a vehicle reservation is made by a user and the vehicle is allocated to the reservation, is described with reference to a timing diagram in FIG. 5. As used in the drawings and description below, a user who makes the vehicle reservation may be designated as “User 1”.

When a vehicle reservation is input to the reservation request input at time T110, the abbreviated process is started at such point in time. In FIG. 5, a processing period of the abbreviated process is represented by an arrow AR10. As mentioned above, since the abbreviated process completes in a short period of time, the abbreviated process completes at time T120, which occurs shortly after time T110.

The simple process in the present embodiment is processing which allocates a vacant electric vehicle 30 to the vehicle reservation on a first-come, first-serve basis without taking the operation cost E into consideration. Therefore, when a vacant electric vehicle 30 is available for rent, the available electric vehicle 30 is allocated to the vehicle reservation. That is, the allocations of the electric vehicles 30 to the other, prior vehicle reservations are not changed by performing the simple process for the subject vehicle.

At time T120, i.e., when the abbreviated process is complete, transmission of a reservation result is transmitted to User 1. As described above, the information that specifies which electric vehicle 30 is allocated to the vehicle reservation is included in the reservation result.

After completion of the abbreviated process, the optimization process starts subsequently. In FIG. 5, a processing period for the optimization process is represented by an arrow AR20. In this example, since User 1 has already received the reservation result at T120, and User 1 may not provide any further input into personal computer 40 for the reservation process and may exit any reservation application running on the personal computer 40.

In the example of FIG. 5, a rental start time shown in the vehicle reservation is designated as time T140. The time from the completion of the simple process at time T120 to time T140 is a relatively-long period, that is, longer than the time required for performing the optimization process (i.e., longer than the length of the arrow AR20). Therefore, the optimization process is complete at time T130 before the rental start time (T140).

When the optimization process is complete and the allocation of the electric vehicle 30 to the vehicle reservation is changed at time T130, such change of the vehicle reservation is transmitted to the User 1 at time T130.

The updated reservation result information showing the updated allocation of the electric vehicle 30, for example, is transmitted from the result transmitter 120 to the personal computer 40 or a portable communication device (i.e. smart phone, tablet, and the like) of User 1. As described above, the allocation information reservation result may also be considered as “updated by the optimization process.”

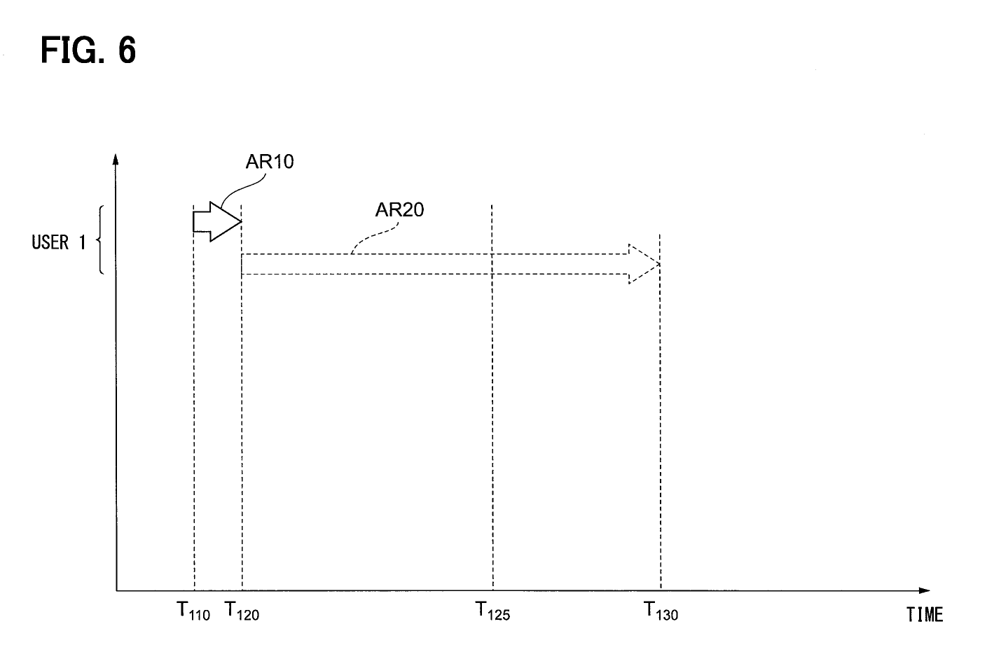

There may be instances where a period of time from the completion of the simple process to the rental start time is relatively short, and the optimization process cannot be completed within such a period of time. Such an example is shown in FIG. 6.

In FIG. 6, a processing period for the simple process (i.e., a period from time T110 to time T120) is represented by the arrow AR10.

As also illustrated in FIG. 6, the rental start time is time T125, which is earlier than the completion of the optimization process at time T130. That is, a period of time from time T120, at which the simple process completes, to time T125, that is the rental start time, is shorter than a period of time from T120 to T130 for the optimization process (i.e., the time from T120 to T125 is shorter than the length of the arrow AR20).

In such case, the reservation processor 130 does not perform the optimization process, and confirms the vehicle allocation of the electric vehicle made during the simple process is the same as the vehicle allocation as determined by the optimization process, i.e. a final vehicle allocation to the vehicle reservation made by User 1.

The determination of whether to perform the optimization process or not may be made based on a comparison between: (i) a period of time from completion of the simple process to a rental start time; and (ii) a predetermined threshold value.

The optimization process is performed when the period of time from completion of the simple process to the rental start time is equal to or greater than the threshold value. The threshold value may be set to define a period of time for the completion of the optimization process, or a period of time of greater duration than the optimization process

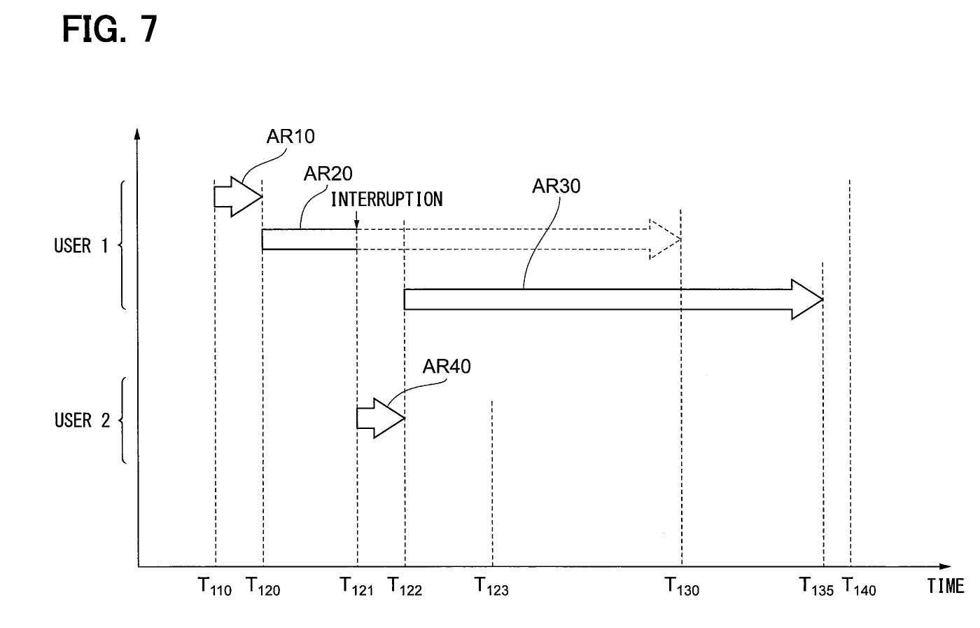

Another example of the processing performed by system 100, when a plurality of vehicle reservations are made by a plurality of users and a vehicle is allocated to a reservation, is described with reference to a timing diagram in FIG. 7.

As shown in FIG. 7, User 1 makes a first vehicle reservation at time T110, and the abbreviated process associated with the first vehicle reservation is performed from time T110 to time T120, as shown by arrow AR10. The rental start time for the vehicle reserved by User 1 is T140.

At time T120, the optimization process of the vehicle reserved by User 1 is started, as shown by arrow AR20.

With continued reference to the example illustrated in FIG. 7, at time T121, a point in time after T120 and before time T130, another user, User 2, makes a second, subsequent vehicle reservation. In such case, the optimization process being performed for the first vehicle reservation made by User 1 is interrupted. Between time T121 and T122, the simple process for the second vehicle reservation made by User 2 is performed, as shown by arrow AR40. In such manner, an electric vehicle 30 is allocated to the second vehicle reservation made by User 2.

When the simple process shown by arrow AR40 is complete at time T122, a reservation result includes information showing a vehicle allocation is transmitted to User 2.

A rental start time for the second, subsequent vehicle reservation made by User 2 is at time T123. Accordingly, the period of time from the completion of the simple process at time T122 to the rental start time at T123 may be shorter than a threshold value.

Therefore, the optimization process for the second vehicle reservation made by User 2 is not performed, but the allocation of the electric vehicle 30 to the second vehicle reservation is finalized or fixed, i.e., fixedly determined, at time T122.

After completion of the simple process for the second vehicle reservation made by User 2, the interruption of the optimization process for the first vehicle reservation made by User 1 stops, and the optimization process resumes, as shown by arrow AR30.

A period of time from time T122, where the optimization process of the first reservation is resumed, to the rental start time for the first reservation at T140, is longer than the period to complete the optimization process for the first reservation, i.e. the period from time T122 to time T135, as shown by arrow AR30. Therefore, the optimization process is complete at time T135 before the rental start time at T140.

When the optimization process shown by arrow AR30 is complete, the electric vehicle 30 originally allocated to the first vehicle reservation made by User 1 is changed (for example, allocated to the second vehicle reservation made by User 2), and information regarding such change is transmitted to User 1.

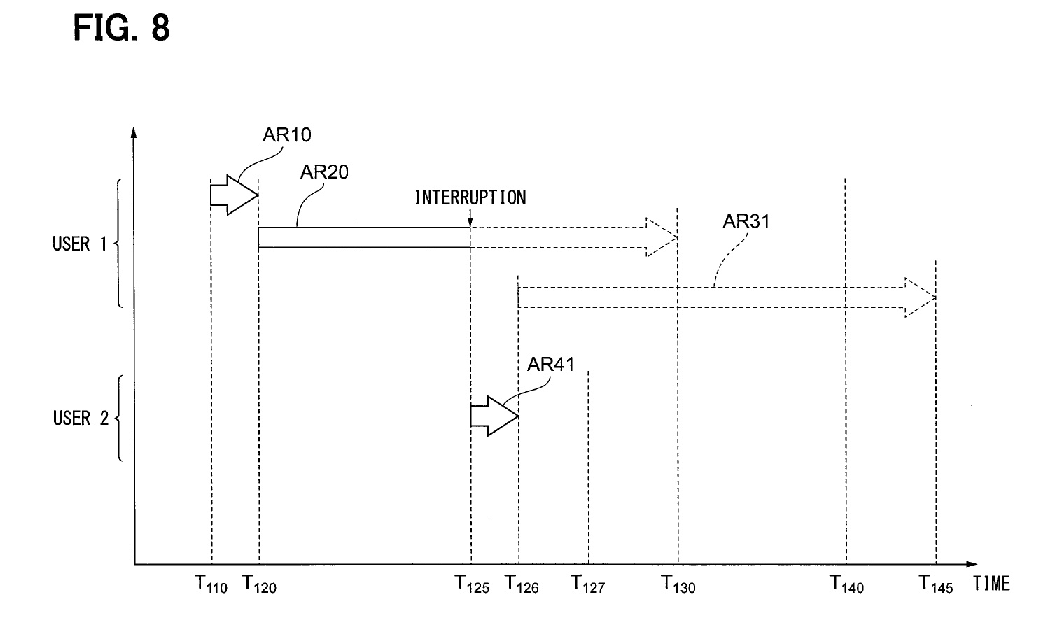

Another example of the processing performed by system 100, when a plurality of vehicle reservations are made by a plurality of users and a vehicle is allocated to a reservation, is described with reference to a timing diagram in FIG. 8. In FIG. 8, User 1 makes a first vehicle reservation at time T110, and the simple process for such reservation is performed in a period of time from time T110 to time T120, as shown by arrow AR10. The rental start time for the first vehicle reservation is at time T140. Therefore, at time T120, the optimization process for the first vehicle reservation is started, as shown by arrow AR20.

At time T125, a point in time after T120 and before time T130, another user, User 2, makes a second vehicle reservation.

The optimization process for the first vehicle reservation made by User 1 is interrupted at time T125.

After time T125, an abbreviated process for the second vehicle reservation made by User 2 is performed, as shown by arrow AR41 and an electric vehicle 30 is allocated to the second vehicle reservation made by User 2.

When the simple process for the second vehicle reservation is complete at time T126, a reservation result including the information regarding vehicle allocation is transmitted to User 2.

A rental start time for the second vehicle reservation made by User 2 is at time T127. A period of time from the completion of the simple process for the second vehicle reservation at time T126 to the rental start time at T127 is shorter than a threshold value. Therefore, the optimization process for the second vehicle reservation made by User 2 is not performed and the allocation of an electric vehicle 30 to the second vehicle reservation is finalized or fixed, i.e., fixedly determined, at time T126.

The interrupted optimization process for the first reservation made by User 1, if resumed at time T126, will complete at time T145, as shown by arrow AR31.

Accordingly, since the interruption of the optimization processing for the first reservation occurs later in the optimization process, for example as compared to the example illustrated in FIG. 7, and the completion time of the simple process for the second reservation occurs at time T126, the new completion time for the optimization of the first reservation will be completed at T145, a point in time after the desired rental time start T140 for the first reservation made by User 1. That is, when it is determined that a duration and a completion of an optimization process resumed after an interruption, for example, the resumed optimization process for the first reservation by User 1, as shown by arrow AR31, will be longer in duration and occur after the desired rental start time, i.e., T140, selected by User 1, the reservation processor 130, allocates an electric vehicle 30 to the first vehicle reservation immediately following the completion of the simple process for the first reservation, as shown by arrow AR10, without performing the optimization process. Such a vehicle allocation is final and conclusive, and the system 100 fixes a vehicle allocation to the first vehicle reservation made by User 1.

As discussed above, for vehicle management system 100, when a new vehicle reservation is input to the reservation request input 110, the reservation processor 130 performs the abbreviated process for allocating an electric vehicle to the respective vehicle reservation. Then, the result transmitter 120 transmits the reservation result back to the user.

In such case, when a period of time between a user's reservation of a vehicle and the rental start time of the vehicle reservation is equal to or greater than the predetermined threshold value, the reservation processor 130 performs an optimization process. Thereby, the allocation of an electric vehicle 30 to the vehicle reservation is updated.

As described above, the vehicle management system 100 may perform a two-part vehicle allocation, as both a simple process that completes the allocation of the electric vehicle 30 to a vehicle reservation in a short period of time, and as an optimization process in which allocation of the electric vehicle 30 is updated/reconsidered so that an operation cost, E, is minimized.

In such manner, the vehicle management system quickly responds to a user who making a vehicle reservation (i.e., quickly transmitting a reservation result), and provides an efficient operation of a vehicle sharing service in a low cost manner.

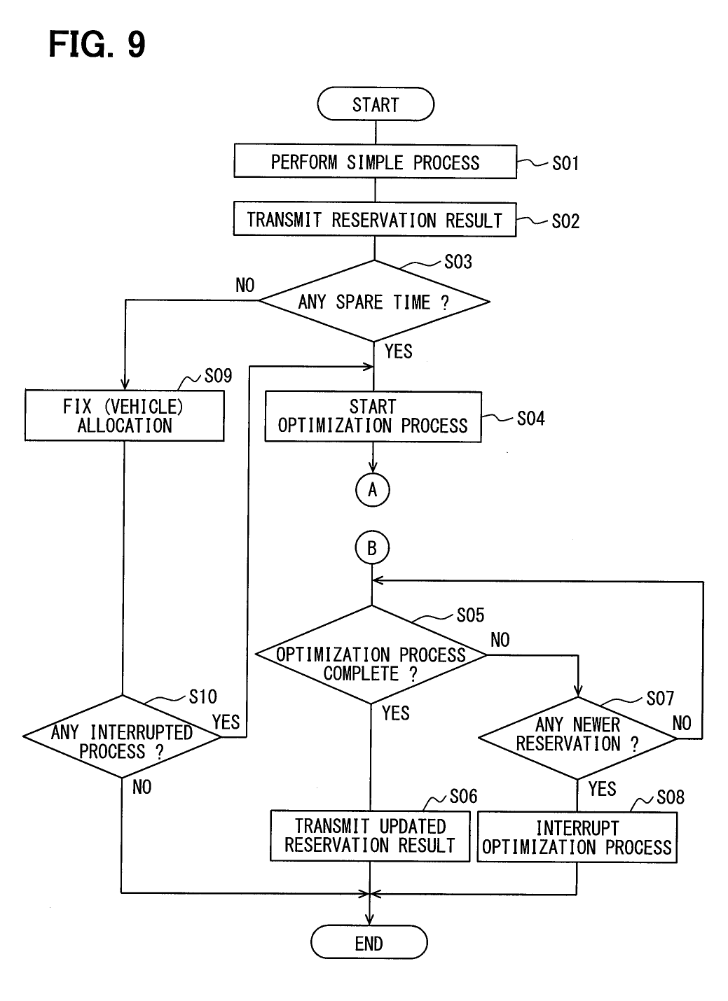

A process performed by the vehicle management system 100, in response to the reservation request input 110 receiving a vehicle reservation request by a user, is described with reference to FIG. 9.

Note that, when two or more vehicle reservations are input to the reservation request input 110 by two or more different users at the same time, the process shown in FIG. 9 is performed concurrently for each of the vehicle reservations.

As described herein, a new vehicle reservation triggering the process illustrated in FIG. 9 may also be designated as a ‘new reservation’ to distinguish the ‘new reservation’ from other vehicle reservations already input into the system 100, i.e., reservations made prior to the new vehicle reservation.

At S01, the simple process is performed by the reservation processor 130. When the simple process is complete, the process proceeds to S02. In S02, a transmission of the reservation result to the user is performed by the result transmitter 120.

Note, when there are no electric vehicles 30 available to accommodate the new reservation, the reservation result showing such a result is transmitted in S02. In such case, the operation system ends the process shown in FIG. 9 after S02.

In S03, the system determines whether there is time for performing the optimization process.

When the system determines in S03 that the period of time from the completion of the simple process to the rental start time is equal to or greater than a threshold value, (i.e. YES indication), the process proceeds to S04.

Having proceeded to S04 means that, as shown in the example of FIG. 5, the optimization process may be completed by a rental start time. Therefore, the optimization process is started accordingly.

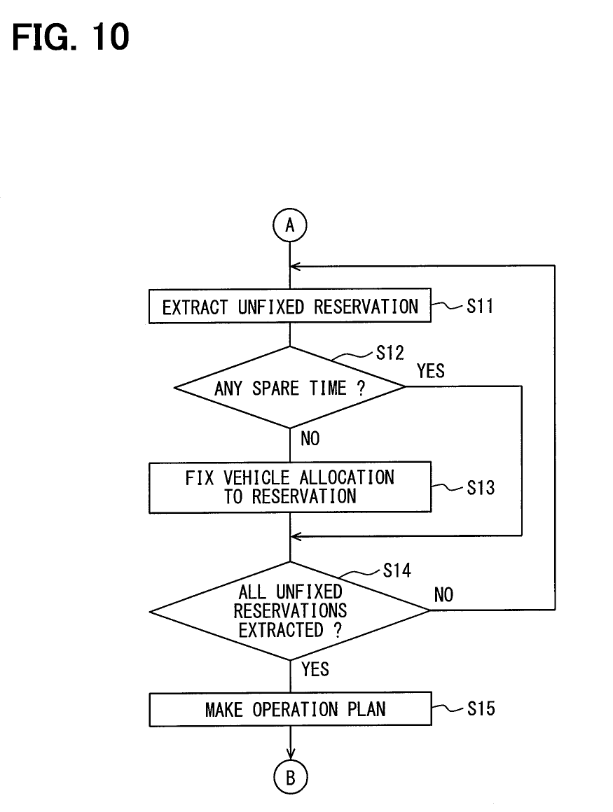

For the optimization process performed after S04, the process jumps from connector A in FIG. 9 to connector A in FIG. 10, and returns to connector B in FIG. 9, after completing S15 shown in FIG. 10.

Prior to describing the process of FIG. 10, “a fixed reservation” and “an unfixed reservation” are described.

In the vehicle management system 100, all the inputs of the vehicle reservation are categorized and stored into a memory of system 100 as either a fixed reservation or an unfixed reservation.

The fixed reservation is a vehicle reservation where changing the allocation of the electric vehicle 30 to a user is prohibited, for example, due to the short period of time between a user making a vehicle reservation and the vehicle rental start time. In other words, the reservation of a vehicle 30 to a user reservation request is fixed and cannot be changed.

The unfixed reservation is a vehicle reservation in which there is extra time available prior to the vehicle rental start time, and the allocation of the electric vehicle 30 to a user may be changed. For example, the time between a user making a vehicle reservation and the vehicle rental start time is long enough to allow the vehicle allocation to the user to be changed.

In S11, one unfixed reservation is extracted from the prior (i.e., already input before the “new” reservation) vehicle reservations.

In S12, the system 100 determines whether there is any additional time for performing the optimization process for the unfixed reservation. In such case, when a period of time from the completion of the simple process to the rental start time is equal to or greater than a threshold value, the system 100 determines there is enough time to perform an optimization process. When there is time for the optimization process, the process proceeds to S14, without performing S13. When there is not enough time to perform the optimization process, the process proceeds to S13.

When the process proceeds to S13, the allocation of the electric vehicle to the corresponding unfixed reservation becomes fixed so that it may not be changed. That is, an unfixed reservation is changed to a fixed reservation at S13 and the process proceeds to S14.

In S14, the system 100 determines whether processing for all the unfixed reservations after S12 has been performed.

When there are any prior, unfixed reservations which have not yet undergone processing after S12, the process returns to S11 and the next unfixed reservation is extracted and processed, as described by S11 and S12.

When processing after S14 has been performed for all the prior, unfixed reservations, the process proceeds to S15.

In such manner, by performing processing from S11 to S14 for all the unfixed reservations, all the unfixed reservations having no additional spare time to perform an optimization process prior to the rental start time are changed from unfixed reservations to fixed reservations.

In S15, the operation plan, i.e., the plan made up from the charge plan {p_{i,j}(τ|t)}, the vehicle allocation plan {a_{j,k}(τ)}, and the vehicle position plan {x_{i,j}(τ|t)}, is generated to minimize the operation cost E.

Although the method of generating the operation plan and its subcomponents is described above, the operation plan is generated based on an assumption that a part of the vehicle allocation plan {a_{j,k}(t)} corresponding to the fixed reservation will not be changed.

That is, among all the vehicle reservations (i.e., more precisely one or more already-input or prior vehicle reservations), the allocation of an electric vehicle 30 is updated by the reservation processor 130 for the prior, unfixed reservation(s), in addition to updating the vehicle allocation to the new, subsequent reservation.

Returning to connector B in FIG. 9, as shown after S04, when the optimization process is started, the process proceeds to S05.

In S05, the system 100 determines whether the optimization process is complete. When the optimization process is complete, the process proceeds to S06.

In S06, the reservation result data updated by the optimization process is transmitted to a user (i.e., transmitted to a user's personal computer 40 for display to the user) from the result transmitter 120.

When the allocation of the electric vehicle 30 to the new, subsequent reservation is changed, a reservation result is transmitted to the user making the new reservation.

When the allocation of the electric vehicles 30 to the vehicle reservations other than the new reservation is changed, i.e. to the prior vehicle reservation requests, a reservation result is also transmitted to the user(s) who made the corresponding vehicle reservation(s).

Transmission of the reservation result to the user is not performed for the vehicle reservation(s) where allocation of the electric vehicle 30 is not changed.

Note, that a notice indicating that the allocation of an electric vehicle 30 has changed, may be performed in manners different than the manner described above.

For example, a user may be presented with a notice when visiting the station 20, and such notice regarding a change of vehicle allocation may be posted on a bulletin board or the like.

In S05, when the optimization process is not yet complete, the process proceeds to S07.

In S07, the system 100 determines whether another new, i.e., “newer”, reservation, which occurs after or subsequent to the new reservation described above, is input after the new reservation.

When the system 100 does not detect the input of any newer (i.e. subsequent) vehicle reservations, the optimization processing at S05 is performed again.

When a newer vehicle reservation is input, the process proceeds to S08.

In S08, the optimization process started in S04 is interrupted, and the processing method shown in FIG. 9 is finished. Interruption of the optimization process performed at S08 is similar to the interruption at time T121 in FIG. 7, and the interruption at time T125 in FIG. 8.

That is, when the reservation processor 130 is performing the optimization process for a first vehicle reservation request, in instances where a second, newer vehicle reservation request is input to the reservation request input 110, the reservation processor 130 interrupts the optimization process being performed for the first vehicle reservation request.

Note that the “newer” reservation is accommodated by concurrently performing the processing method shown in FIG. 9. Such processing is similar to the processing that occurs at arrow AR40 in FIG. 7, and processing that occurs at arrow AR41 in FIG. 8.

In S03, when the system 100 determines that there is no additional time for performing the optimization process, the process proceeds to S09.

Having proceeded to S09 means that a period of time from the completion of the simple process to the rental start time, for example, as indicated by the new reservation, is shorter than the threshold value, and the optimization process therefore cannot be performed.

Therefore, at S09, the allocation of the electric vehicle 30 to the new reservation is fixed to what has been allocated by the simple process in S01. That is, the vehicle allocated to the new reservation request during the simple process is fixed, and the new reservation is set as a fixed reservation.

After performing the simple process, when a period of time to from the end of the simple process to the rental start time for the new reservation is determined to be shorter than the threshold value, the reservation processor 130 fixes the allocation of the electric vehicle 30 to the new reservation request performed in the simple process, and does not change the corresponding vehicle allocation thereafter.

At S10, the system 100 determines whether any optimization processes were interrupted at S08. That is, the system 100 determines whether other vehicle reservations exist, where the respective optimization process was interrupted due to an input of a new reservation, i.e. newer than the existing vehicle reservation request.

When the system 100 determines that no optimization processes have been interrupted, the processing method shown in FIG. 9 is finished.

If system 100 determines that optimization processes have been interrupted the processing method after S04 is performed again. In such a manner, the allocation of an electric vehicle 30 to one or more vehicle reservations that have already been input into the system 100 (i.e., all the reservations prior to the new reservation) is analyzed, and the vehicle allocation for the unfixed reservation, where the allocation of the electric vehicle 30 is not yet fixed, is updated.

The optimization process started at S04 and continuing to S10 is similar to the processing that occurs at arrow AR30 in FIG. 7.

However, there may be instances where an interrupted optimization process may be changed from an unfixed reservation to a fixed reservation after a lapse of time, for example, as represented by the process performed at S13 in FIG. 10. In such case, the interrupted optimization process is not performed again.

As discussed above in regard to the example shown in FIG. 8, a result of the simple process performed prior to the optimization process may be finalized with regard to the allocation of the electric vehicle 30 to the vehicle reservation.

The examples described herein use electric vehicles 30 as the vehicles used in the vehicle sharing service, however, such vehicles 30 are not limited to electric vehicles. For example, the vehicle sharing service can also use “hybrid” vehicles having both a storage battery and an internal-combustion engine.

Further, the service vehicles 30 may also be wholly powered by internal-combustion engines. In such case, the operation cost E can still be calculable, for example, by omitting the second term and the third term from Equation 1, leaving only the vehicle transfer cost to be calculated.

Although the present disclosure has been practically described in connection with an embodiment thereof with reference to the accompanying drawings, it is to be noted that various changes and modifications become apparent to those skilled in the art.

For example, the above-described embodiment may have different configurations, in terms of different component arrangement, different material, different conditions, different shapes, different sizes and the like, other than the ones described above.

Further, different embodiments and the components used therein may be partially or as a whole combinable, unless otherwise described.

Such changes, modifications, and summarized schemes are to be understood as being within the scope of the present disclosure as defined by appended claims.

What is claimed is:

1. A vehicle management system for managing a vehicle-sharing service of one or more vehicles at one or more vehicle service stations, the vehicle management system comprising:
a reservation request input configured to receive a vehicle reservation request from an external computing device;
a reservation processor configured to allocate a vehicle to the vehicle reservation request;
a result transmitter configured to transmit a reservation result including a rental start time of the vehicle to the external computing device; and
a cost calculator configured to calculate an operation cost of the vehicle-sharing service, wherein
the reservation processor is further configured to perform either a simple process or the simple process and an optimization process, for a vehicle allocation, wherein
the simple process allocates the vehicle within a first processing time by either omitting a calculation of the operation cost by the cost calculator or simplifying the calculation of the operation cost by the cost calculator, and
the optimization process allocates the vehicle within a second processing time using the cost calculator to calculate the operation cost based on a given condition to minimize the operation cost, and wherein
the first processing time is shorter than the second processing time.

2. The vehicle management system of claim 1, wherein after completing the simple process, when a time remaining before the rental start time is greater than or equal to a threshold value, the reservation processor performs the optimization process for the vehicle allocation.

3. The vehicle management system of claim 1, wherein after completing the simple process, when a time remaining before the rental start time is less than a threshold value, the reservation processor fixes the vehicle to the vehicle reservation request and prohibits changing the vehicle allocated to the vehicle reservation request.

4. The vehicle management system of claim 1, wherein when a subsequent vehicle reservation request is received by the reservation request input, the reservation processor is further configured to update a vehicle allocation to any prior unfixed vehicle reservation requests and the subsequent vehicle reservation request by performing the optimization process.

5. The vehicle management system of claim 1, wherein when a subsequent vehicle reservation request is received by the reservation request input while the reservation processor is performing the optimization process for a vehicle allocation of a prior reservation request, the reservation processor interrupts the optimization process for the prior reservation request.

6. The vehicle management system of claim 1, wherein when a subsequent vehicle reservation request is received by the reservation request input, the reservation processor first performs the simple process for a vehicle allocation to the subsequent vehicle reservation request and fixes the vehicle allocation to the subsequent vehicle reservation request when a time remaining before the rental start time of the vehicle allocated to the subsequent vehicle reservation request is less than a threshold value, and the reservation processor subsequently updates vehicle allocations for any prior unfixed vehicle reservation requests by performing the optimization process for each of the prior unfixed vehicle reservation requests.

7. The vehicle management system of claim 1, wherein the result transmitter is further configured to transmit an updated reservation result with updated vehicle allocation information to the external computing device after the reservation processor performs the optimization process.

8. The vehicle management system of claim 1, wherein the one or more service stations includes a charge facility configured to supply electric power for charging the one or more vehicles from either a solar-generated electric power supply or a grid-supplied electric power supply, and wherein
the costs calculator calculates an operation cost of the vehicle-sharing service by forecasting an amount of electric power supplied by the solar-generated electric power supply at the one or more service stations.

9. The vehicle management system of claim 8, wherein the cost calculator further calculates the operation cost of the vehicle-sharing service including a grid-charge for the electric power from the grid-supplied electric power supply used to charge the one or more vehicles.

10. The vehicle management system of claim 1, wherein the costs calculator calculates the operation cost of the vehicle-sharing service including a vehicle transfer operation cost.
